(19) United States
(12) Patent Application Publication
(10) Pub. No.: US 2007/0070205 A1
(43) Pub. Date: Mar. 29, 2007

(54) Web cam

(75) Inventors: Wei Cheng Huang, Taipei County (TW); Hui Yi Lin, Taipei City (TW)

Correspondence Address: BACON & THOMAS, PLLC, 625 SLATERS LANE, FOURTH FLOOR, ALEXANDRIA, VA, 22314, US

(73) Assignee: CHICONY ELECTRONICS CO. LTD., Taipei County (TW)

(21) Appl. No.: 11/355,893

(22) Filed: Feb. 17, 2006

(30) Foreign Application Priority Data
Sep. 26, 2005 (TW) 94216545

(51) Int. Cl. H04N 9/04; H04N 5/225

(52) U.S. Cl. 348/207.99

(57) ABSTRACT

A web cam is provided, comprising: a body, having a receiving space for receiving a lens, and two supporting arms extending from the periphery of the body; a shell from which a pivot connecting part is extended; and a connecting element, passing through the holes of the supporting arms of the body and the holes of the pivot connecting part of the shell, such that the shell is rotatable with respect to the body, thereby the shell can cover or move away from one side of the body having the lens.

### BACKGROUND OF THE INVENTION

1. Field of the Invention

The present invention relates to a web cam, and especially to a web cam capable of combining with a chucking element.

2. Description of the Related Art

With the popularization of the wideband network, more and more users can make a remote communication via computer peripherals, such as audio and video devices. It is common seen to use the combination of a microphone and an audio card by which voice information can be transmitted and a web cam by which the image of the user can be captured and transmitted.

With the popular application of the on-line video conference, various types of web cams are available in the market. However, most current web cams usually comprise a base and a left and right and/or up and down adjustable camera mounted on the base. However, such design is only suitable for setting on a plane surface. Moreover, the volume of current web cams is bulky and a large space is occupied.

A web cam that can be used for a video conference only when it is placed in a plane can not satisfy the current demand. Because a notebook computer that can be used anytime and anywhere has become a necessary apparatus for a current worker, however, when a notebook computer is used for video communication, a plane is not necessarily provided. For example, when a user bends his knees and put his notebook computer on his knees, it will be difficult to provide a plane on which the web cam can be put to make a successful video communication.

### SUMMARY OF THE INVENTION

It is one objective of the present invention to provide a web cam which not only can be put on an ordinary plane, but also can combine with a chucking element for clamping various flat panel displays, such as liquid crystal displays or displays for notebook computer.

To achieve the above objective, a web cam according to the present invention comprises: a body, having a receiving space for receiving a lens, and two supporting arms extending from the periphery of the body; a shell from which a pivot connecting part is extended; and a connecting element, passing through holes of the supporting arms of the body and holes of the pivot connecting part of the shell, such that the shell can be rotated with respect to the body, thereby the shell can cover or move away from one side of the body having the lens.

Preferably, the web cam according to the present invention further comprises a chucking element including an L-shaped part and a clasp part. The chucking element can combine with the pivot connecting part of the shell by the clasp part.

Preferably, the chucking element further comprises an L-shaped soft mat combined with the L-shaped part of the chucking element, such that when the L-shaped part of the chucking element clamps a liquid crystal display or the display for a notebook computer, the L-shaped soft mat may protect the L-shaped part of the chucking element, or protect the clamped portion of the liquid crystal display or the display for a notebook computer.

Preferably, the connecting element comprises a screw bolt, a screw nut, and a washer.

### BRIEF DESCRIPTION OF THE DRAWINGS

FIG. 1 is an exploded view of the web cam and the chucking element of the present invention.

FIG. 2 is a perspective view of the web cam and the chucking element of the present invention.

FIG. 3 is an exploded view of the web cam and the chucking element of the present invention.

FIG. 4 is a view illustrating one preferred use state of the web cam of the present invention.

FIG. 5 is an exploded view of the web cam and the chucking element of the present invention.

FIG. 6 is a combined view of the web cam and the chucking element of the present invention.

FIG. 7 is a view illustrating another preferred use state of the web cam of the present invention.

### DETAILED DESCRIPTION OF THE PREFERRED EMBODIMENTS

Although the present invention has been described in considerable detail with reference to certain preferred embodiments thereof, however prior to this description, it should be understood that those skilled in the art can easily make changes to the present invention described herein and the same performance as the present invention is obtained. Therefore, it is to be understood that the following description is a general disclosure to those skilled in the art and is not restrictive of the present invention.

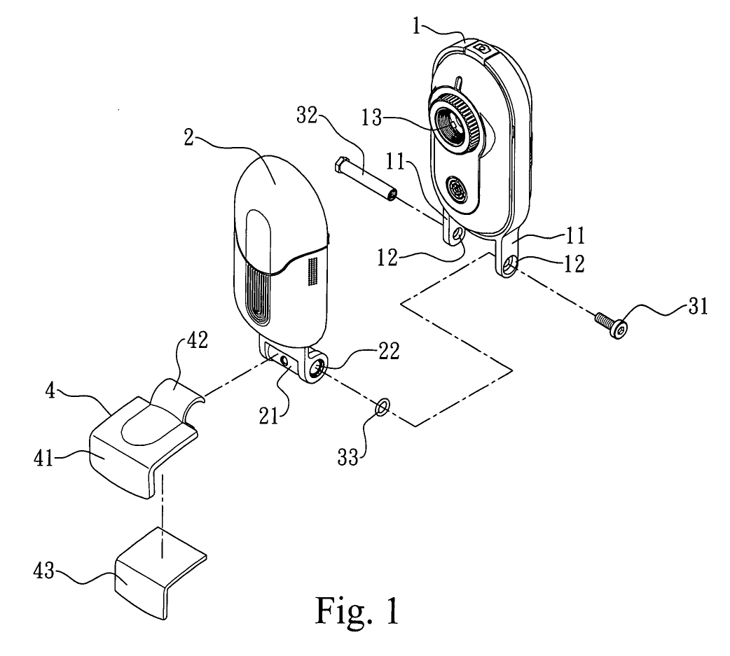

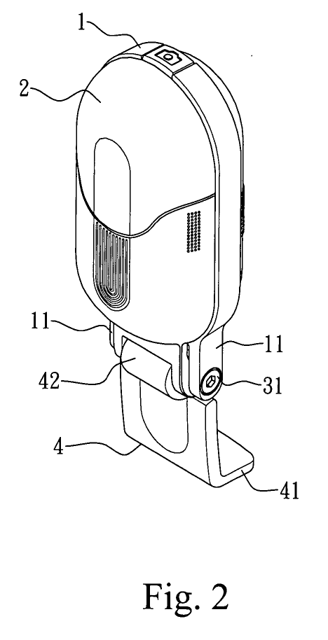

Referring to FIG. 1 and FIG. 2, an exploded view and a perspective view of the web cam and the chucking element of the present invention are respectively shown. The present web cam comprises a body 1, having a receiving space (not shown) for receiving a lens 13, and two supporting arms 11 extending from the periphery of the body 1; a shell 2 from which a pivot connecting part 21 is extended; and a connecting element comprising a screw bolt 31, a screw nut 32, and a washer 33, the screw nut 32 will sequentially pass through the hole 12 of the supporting arm 11, the holes 22 of the pivot connecting part 21, the washer 33, and the hole 12 of the supporting arm 11, and finally tightly locked with the screw bolt 31, such that the shell 2 can be rotated with respect to the body 1, thereby the shell 2 can cover or move away from one side of the body 1 having the lens 13. Further, the present web cam is electrically connected to a computer via a conductive line (not shown).

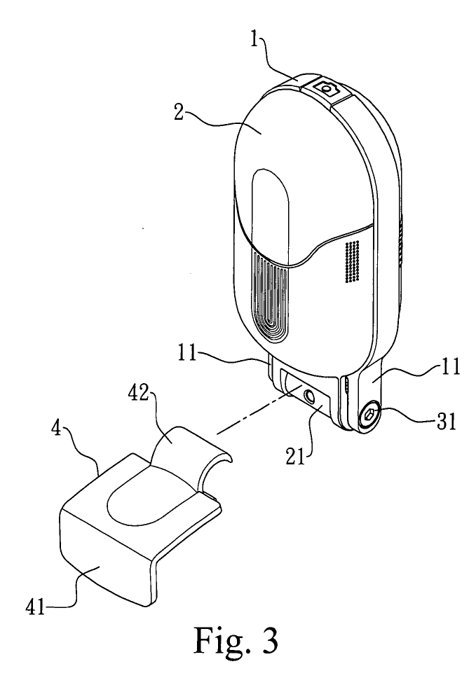

The chucking element 4 comprises an L-shaped part 41 and a clasp part 42. With the clasp part 42 being engaged with the pivot connecting part 21, the chucking element 4 can thus combine with the web cam. This is convenient for the user to carry it and the chucking element 4 will not be lost. Further, the chucking element 4 comprises a L-shaped soft mat 43 combined with the L-shaped part 41 of the chucking element 4, such that when the L-shaped part 41 of the chucking element 4 clamps a liquid crystal display or the display for a notebook computer, the L-shaped soft mat 43 may protect the L-shaped part 41 of the chucking element 4, or protect the clamped portion of the liquid crystal display or the display for a notebook computer. Referring to FIG. 3 for an exploded view of the web cam and the chucking element of the present invention, as shown in this figure, the chucking element 4 can be dismounted and used as a separate element independent with the web cam.

### Embodiment 1

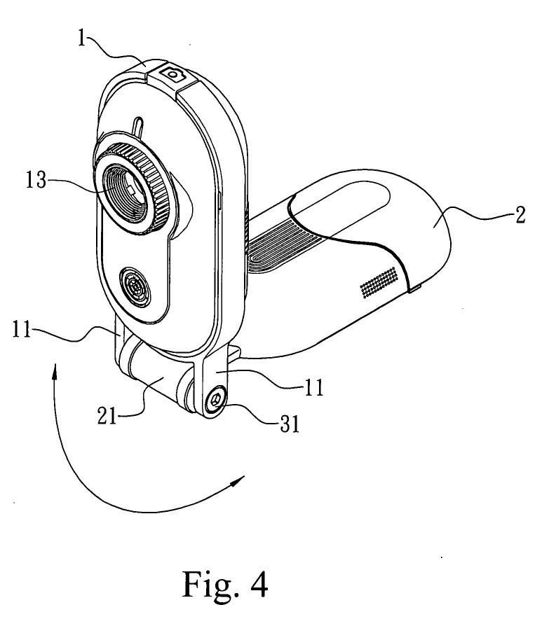

Referring to FIG. 4, a view illustrating one preferred use state of the web cam of the present invention is shown. In this preferred embodiment of the present invention, the shell 2 is rotated (along the direction indicated by the two-way arrow shown in FIG. 4) with respect to the body 1, when the shell 2 has moved away from one side of the body 1 having the lens 13 and arrived at the other side of the body 1, the web cam can be put on the table or other planes by using the other side of the shell 2 and the pivot connecting part 21 as a touching face.

### Embodiment 2

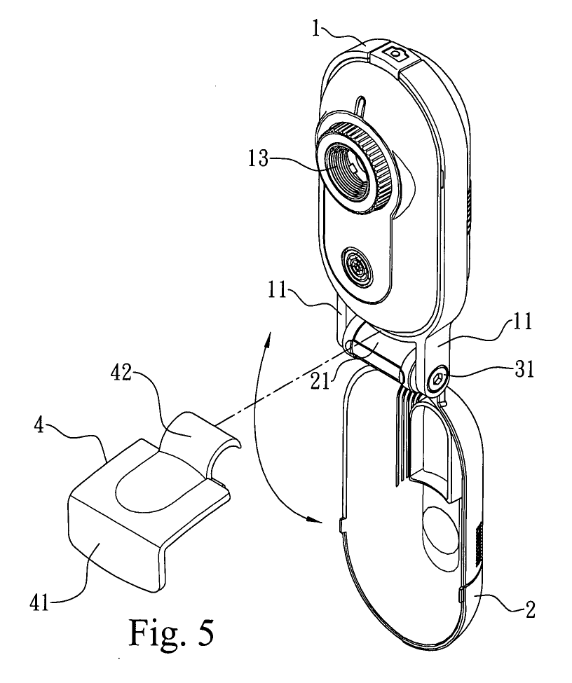

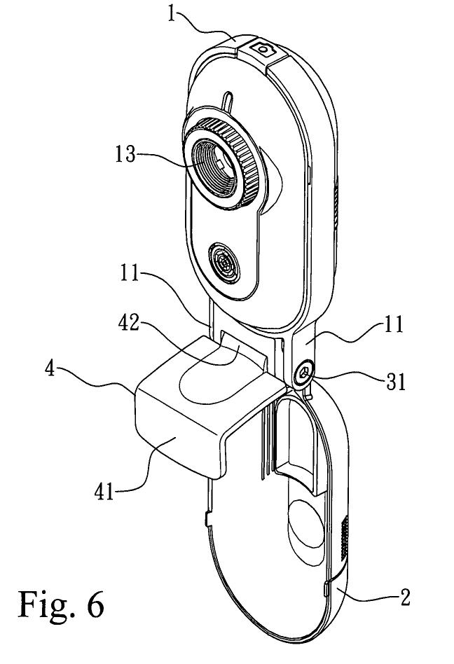

Referring to FIG. 5 and FIG. 6, an exploded view and a combined view of the web cam and the chucking element of the present invention are respectively shown. In this preferred embodiment of the present invention, the shell 2 is rotated (along the direction indicated by the two-way arrow shown in FIG. 5) with respect to the body 1, when the shell 2 has moved away from one side of the body 1 having the lens 13 and formed an appropriate angle with respect to the body 1, the user can engage the chucking element 4 with the pivot connecting part 21 by means of the clasp part 42, such that the chucking element 4 can thus combine with the web cam into an integral device.

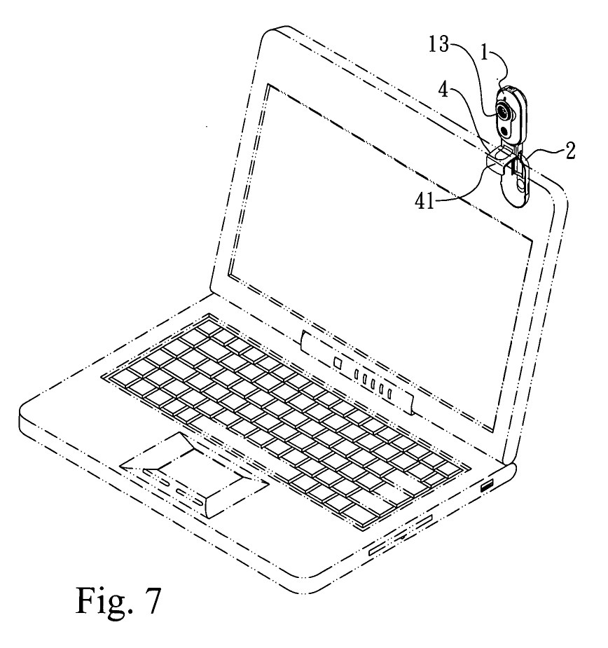

Continuing referring to FIG. 6 in conjunction with FIG. 7, a view illustrating another preferred use state of the web cam of the present invention is shown in FIG. 7. In the preferred embodiment of the present invention, when the shell 2 is rotated to form an angle of 180° with respect to the web cam and the chucking element 4 is integrated with the web cam, then a finite space will be formed between the chucking element 4 and the shell 2 such that the web cam can use the chucking element 4 to clamp the display of a notebook computer at an appropriate position.

Although the present invention has been described in considerable detail with reference to certain preferred embodiments thereof, those skilled in the art can easily understand that all kinds of alterations and changes can be made within the spirit and scope of the appended claims. Furthermore, the present invention is not limited to the implementation of the embodiments exemplified herein.

What is claimed is:

1. A web cam, comprising:
a body, having a receiving space for receiving a lens, and two supporting arms extending from the periphery of said body;
a shell from which a pivot connecting part is extended; and
a connecting element;
characterized in that:
said connecting element passes through holes of said supporting arms of said body and holes of said pivot connecting part of said shell, such that said shell is rotatable with respect to said body, and thereby said shell can cover or move away from one side of said body having said lens.

2. The web cam as claimed in claim 1, further comprising a chucking element, said chucking element including an L-shaped part and a clasp part, and said chucking element combines with said pivot connecting part of said shell by said clasp part.

3. The web cam as claimed in claim 2, wherein said chucking element further comprises an L-shaped soft mat combined with said L-shaped part of said chucking element.

4. The web cam as claimed in claim 1, wherein said connecting element comprises a screw bolt, a screw nut, and a washer.
